(19) United States
(12) Patent Application Publication
(10) Pub. No.: US 2024/0161211 A1
(43) Pub. Date: May 16, 2024

(54) SYSTEM AND INTEGRATED METHOD FOR DESIGNING, ENGINEERING AND FRAMING A BUILDING FROM PRE-DEFINED, PREFABRICATED LIGHT GAUGE STEEL FRAMING PANELS AND COMPONENTS

(71) Applicant: Accelerated Steel Fabricators, LLC, Plano, TX (US)

(72) Inventors: David Bradley Dean, Frisco, TX (US); Mohamed Elefandi, Prosper, TX (US)

(73) Assignee: Accelerated Steel Fabricators, LLC, Plano, TX (US)

(21) Appl. No.: 18/509,999

(22) Filed: Nov. 15, 2023

Related U.S. Application Data
(60) Provisional application No. 63/383,737, filed on Nov. 15, 2022.

(51) Int. Cl. G06Q 50/08; E04B 2/58

(52) U.S. Cl. CPC G06Q 50/08; E04B 2/58

(57) ABSTRACT

The present system seeks to provide a hybrid design and build system using pre-defined, prefabricated building panel frame assemblies and components that can be manufactured in bulk off-site and then simply and easily connected on-site to form fully functional building structures according to a predetermined panelized building plan. Off-site manufacturing of these frame assemblies in large quantities reduces material waste, reduces labor costs and improves construction efficiency.

### CROSS-REFERENCE TO RELATED APPLICATIONS

This Application claims the benefit of U.S. Provisional Patent Application No. 63/383,737, filed Nov. 15, 2022, titled “System And Integrated Method For Designing, Engineering And Framing A Building From Pre-Defined, Prefabricated Light Gauge Steel Framing Panels And Components”, the entire contents of which are incorporated herein by reference.

### BACKGROUND OF THE DISCLOSURE

### (1) Field of the Invention

The instant invention relates to modular building construction components and techniques, and more particularly to a unique system and integrated method for quickly designing, engineering, and constructing a building using pre-defined, prefabricated building panels and components.

### (2) Description of Related Art

Conventional construction techniques build on-site from a set of general plans and use individual building components to create floors, walls, trusses etc. Some aspects of conventional building have been simplified by pre-fabricating certain structures such as roof trusses, etc., but for the most part, floors and walls are stick-built on-site using individual beam and stud components (wood or metal). This type of construction inherently involves significant onsite labor for measuring and cutting raw materials, along with significant material waste and excess cost.

Modular building panel systems are generally well-known in the construction industry and have attempted to address some of the issues involved with conventional building techniques. In this regard, existing modular panel systems and methodologies focus on attempting to provide fully prefabricated panels or modules which include not only framing, but also wiring, plumbing and interior and exterior finishes to minimize on-site skilled labor. While these existing systems somewhat simplify on-site construction, they still require significant back-end design in that each individual panel must still be custom fabricated from standard building materials and components. These systems shift the custom fabrication from on-site to off-site, but still don't simplify the overall process.

### SUMMARY OF THE DISCLOSURE

The present system seeks to provide a hybrid design and build system using pre-defined, prefabricated building panel frame assemblies and framing components that are standardized based on different light gauge steel criteria and that can be manufactured in bulk off-site and then simply and easily connected on-site to form fully functional building structures. Off-site manufacturing of these frame assemblies in large quantities reduces material waste, reduces labor costs, and improves construction efficiency. This system moves the construction industry forward from stick building with individual raw materials to frame sub-assemblies using larger prefabricated assemblies of individual components which have been pre-defined and assembled off-site in a controlled low-cost environment.

2D and 3D building design, rendering and project management is now almost exclusively completed in complex computer design programs, such as AutoDesk's Revit. These programs allow the designers to specify design constraints for the various building features and to build out complex designs in virtual environment more quickly and efficiently. The systems include integral analysis tools for structural integrity and for specifying materials and calculating costs.

The present system takes this virtual design concept a step further and creates a unique plug-in tool which interacts with the primary 3D design software to create panelized frame sub-assembly construction plans from either an existing conventional building plan (imported pre-existing plan), or to create a panelized construction plan for a new project completely from the beginning design phases.

The core of the system is a database of unique pre-defined prefabricated framing components, panel frames and sub-assemblies which are standardized based on different light gauge steel criteria. The system includes a powerful analytics engine which works from the input design, accesses the database of available components and creates the panelized construction plan and a bill of materials required to complete the construction.

The database of pre-defined, prefabricated framing components comprises multiple different types and sizes of framing components each having a defined structural data profile.

The pre-defined prefabricated framing components may comprise at least the follow types of panels and components:
cantilevered panel assemblies,
convertible panel assemblies,
full panel assemblies,
corner panel components/assemblies,
cassette panel subassemblies,
universal connection tracks,
horizontal bracing & convertible horizontal bracing,
roof truss assemblies:

For shear walls horizontal channel bracing may be used for blocking. Horizontal bracing for blocking can be assembled on site, or offsite. Additionally convertible telescoping bracing can be utilized to the end of the panel spacing.

The panels may generally standardized on three (3) different light gauge steel thicknesses, namely 16-gauge, 18-gauge and 20-gauge, two (2) different on-center spacings, 16″ on center and 24″ (2 Ft) on center, as well as two (2) different stud sizes, namely 3⅝″ and 6″. Thereafter, the panel assemblies may standardized on height (8 ft, 9 ft, 10 ft, and 11 ft), and broken down into panels at 1-foot increments for the two-foot on center panel series (1×8, 2×8 etc.), and 8-inch increments for the sixteen-inch on center panel series

Corner frame assemblies may be standardized on 12″ (1 foot), 16″, 24″ (2 foot) lengths.

The use of 3 different gauges and 2 different spacings provides the system with the ability to frame successive upper floors of a building with lighter steel components which do not need to carry as heavy a load as the lower floors. This simple building criteria can significantly reduce material costs. Accordingly, each set of described panels is reproduced in three separate gauges for consistent design and implementation.

Generally, the cantilevered panels may be open on both sides or only one side and are used in exterior, or interior wall framing. All panels are generally defined by top and bottom C-shaped tracks having a plurality of vertical studs secured therebetween.

The system may further comprise convertible panels which interfit with open ends of the cantilevered panels to create closed ends where needed.

Cantilevered panels are connected at their top and bottom tracks by universal connection tracks sized for the 3 different gauges and two different stud sizes. The cantilevered panel tracks and sidewalls of said universal connection tracks each include mating dimple holes for alignment, fastening, and to host a termination/end stud wherever needed to terminate the end of the panel.

Full panels are closed on both end and are typically used for interior walls.

The pre-defined prefabricated framing components may further comprise a plurality of cassette panels which are structurally adaptable to easily integrate doors and windows framing with its assembled headers into the framing panels. For example, an 8-foot full panel may converted into a cassette by removing the internal vertical studs and sliding a door or window into the required location. Internal vertical studs, and footers are then installed as needed to fill the framing panel back out as it would normally be framed on site.

In some embodiments, the system may include pre-defined roof trusses with progressive pitches from 4-12 to 6-12 to 8-12 pitches and in progressive spans from 10 to 32 feet.

As organized in the system database each component is defined with a unique structural data profile which comprises a data set including at least a stud width, a stud wall thickness (gauge), an on-center dimension, a panel height and a panel width. Likewise, the corner components are defined similarly with the same data set.

In all, there may be hundreds of distinct framing panels and components which make up the complete component system.

Each panel, component and truss of the system is specifically pre-engineered for a particular load, span and weight bearing capability, meaning that a structural engineer has analyzed the panel and component material data for structural stability and use.

Once a design has been completed, the system may catalogue each of the required panels and components and create a bill of materials (BOM) with appropriate panel types, number and costs to complete the design. From the BOM, the builder can have these standardized panels and components built off-site and then shipped to the site for assembly. All like panels can be built at the same time for consistency, repeatability and cost savings.

In some embodiments, the exemplary system may be implemented as a plugin module for a 3D CAD building system, such as AutoDesk Revit, which can be used to create a building design as a new plan, or to import an existing plan and convert it into a panelized plan.

Once designed within or imported into the system, a system analytics engine within the plug-in will panelize the entire building structure from components within the database, suggest dimensional changes that may make the structure more compliant with the standard size panels and create schedules for construction.

### BRIEF DESCRIPTION OF THE DRAWING FIGURES

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a schematic view of an exemplary system architecture in accordance with the teachings of the present invention;

FIG. 2 is an illustration of progressive sizes of cantilevered panels with 2 foot on center spacing and 16 inch on center spacing;

FIG. 3 is an illustration of an in-line cantilevered panel (open on both ends);

FIG. 4 is an illustration of a termination cantilevered panel (open on one end);

FIG. 5 is an illustration of a terminal stud which can be inserted into the end of a cantilevered end to close the open side;

FIG. 6 illustrates the top and bottom track dimple locations for securing adjacent panels together with provided connection tracks;

FIG. 7 is an illustration of a cantilevered panel showing the locations of the dimple holes on all four projecting cantilevered ends;

FIG. 8 is an illustration of progressive sizes of full panels with 2 foot on center spacing and 16 inch on center spacing;

FIG. 9 is an illustration of an full panel (closed on both ends);

FIG. 10 is a perspective illustration of exemplary 8 inch connection tracks for 3⅝ inch stud size and 6 inch stud size and showing the respective dimple spacing for each;

FIG. 11 is an illustration of an exemplary use of the connection track connecting the top tracks of adjacent cantilevered panels;

FIG. 12 is a perspective illustration of an exemplary convertible panel section with top and bottom swaged tracks;

FIG. 13 is an illustration of exemplary sizes of convertible end panels for both 3⅝ inch studs and 6 inch studs;

FIG. 14 is an illustration of an exemplary cassette panel and the stepwise assembly of a window or door with header and foot components sliding into the track of an open cassette panel;

FIG. 15 illustrates conversion of a standard 8 foot full panel into a cassette panel by removing the vertical studs and sliding a door or window (with headers and footers) into the tracks and filling the open spaces with vertical studs;

FIG. 16 is an illustration of an exemplary corner panel assembly with a 3 stud corner configuration to allow for drywall securement;

FIGS. 17-20 are illustrations of varying corner panel sizes for both 3⅝ studs and 6 inch studs on 2 foot and 16 inch on center spacings;

FIG. 21 is an illustration of a horizontal bridging/bracing element used to reinforce construction on shear walls;

FIG. 22 is an illustration of a convertible (telescoping) horizontal bridging/bracing element which can be adjusted longitudinally for length;

FIG. 23 illustrates a naming convention for the present panel construction system;

FIG. 24A illustrates an exemplary pre-engineered truss assembly with a 4-12 roof pitch;

FIG. 24B illustrates a plurality of pre-engineered truss assemblies with progressive pitches from 4-12 to 6-12 to 8-12 pitches and in progressive spans;

FIGS. 25A-24D illustrate an exemplary panelized project plan with panel, truss, window and door schedules in accordance with the teachings of the present panel construction system;

FIGS. 26A-25E illustrate an exemplary construction and design system implemented as a plugin module for a 3D CAD building system, such as AutoDesk Revit, which can be used to create a building design as a new plan; and

FIGS. 27A-26B illustrate an exemplary construction and design system implemented as a plugin module for a 3D CAD building system, such as AutoDesk Revit, which can be used to import an existing building plan and convert it into a panelized plan.

### DETAILED DESCRIPTION OF THE EXEMPLARY EMBODIMENTS

Certain exemplary embodiments will be described to provide an overall understanding of the principles of the structure, function, manufacture, and use of the system and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

The present system seeks to provide a hybrid design and build system using pre-defined, prefabricated building panel frame assemblies and framing components that are standardized based on different light gauge steel criteria and that can be manufactured in bulk off-site and then simply and easily connected on-site to form fully functional building structures. Off-site manufacturing of these frame assemblies in large quantities reduces material waste, reduces labor costs, and improves construction efficiency. This system moves the construction industry forward from stick building with individual raw materials to frame sub-assemblies using larger prefabricated assemblies of individual components which have been pre-defined and assembled off-site in a controlled low-cost environment.

2D and 3D building design, rendering and project management is now almost exclusively completed in complex computer design programs, such as AutoDesk's Revit. These programs allow the designers to specify design constraints for the various building features and to build out complex designs in virtual environment more quickly and efficiently. The systems include integral analysis tools for structural integrity and for specifying materials and calculating costs.

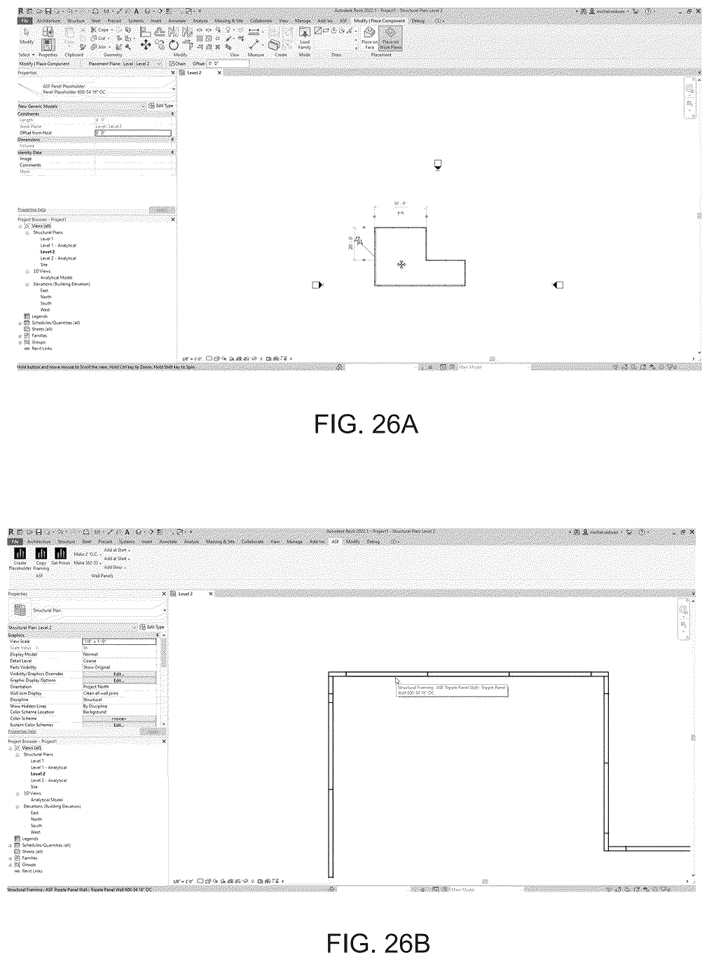

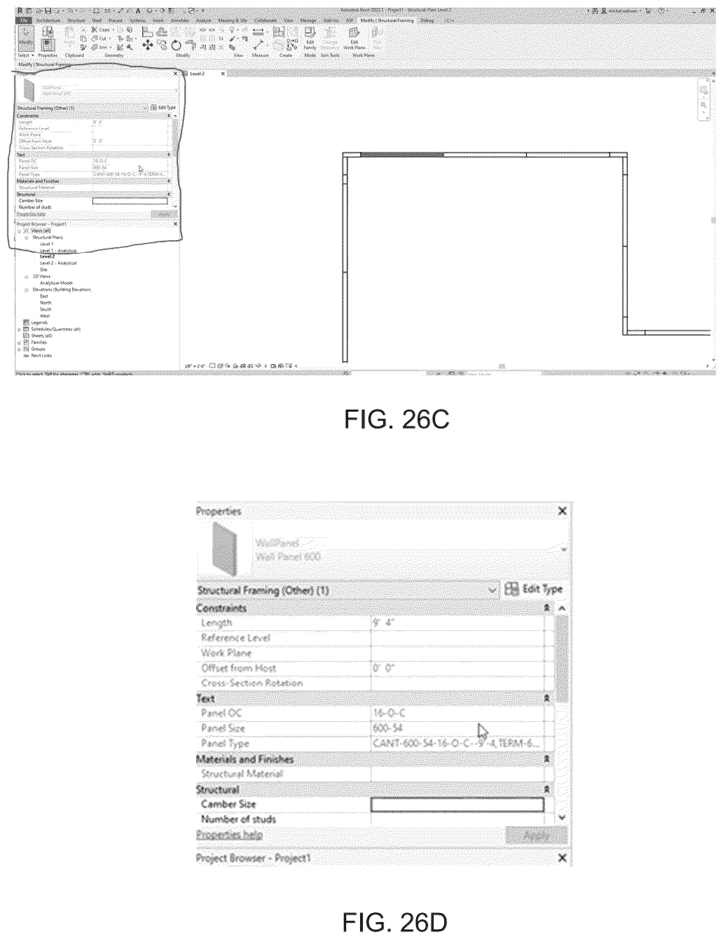

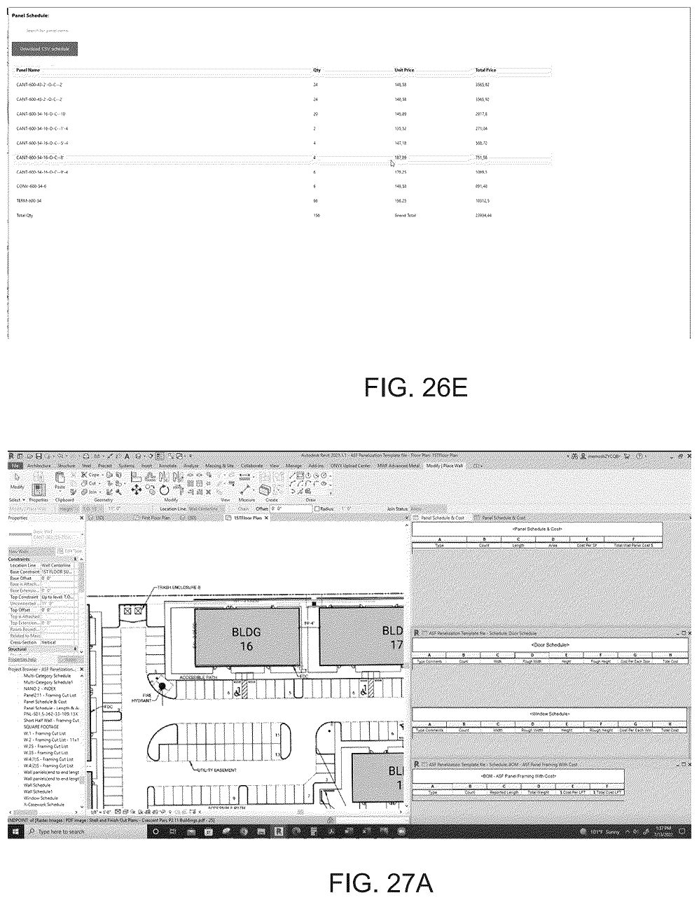

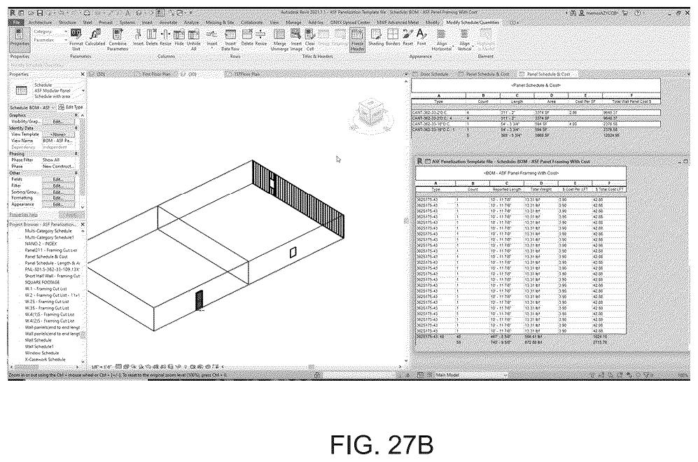

The present system takes this virtual design concept a step further and creates a unique plug-in tool (See FIGS. 26A-27B) which interacts with the primary 3D design software to create panelized frame and truss sub-assembly construction plans from either an existing conventional building plan (imported pre-existing plan), or to create a panelized construction plan for a new project completely from the beginning design phases.

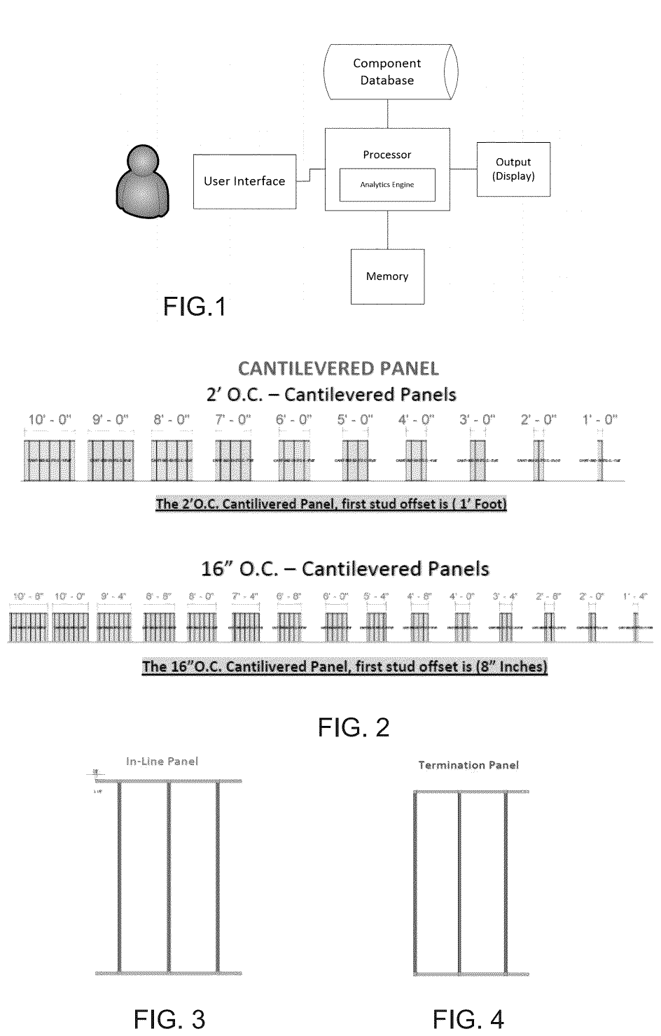

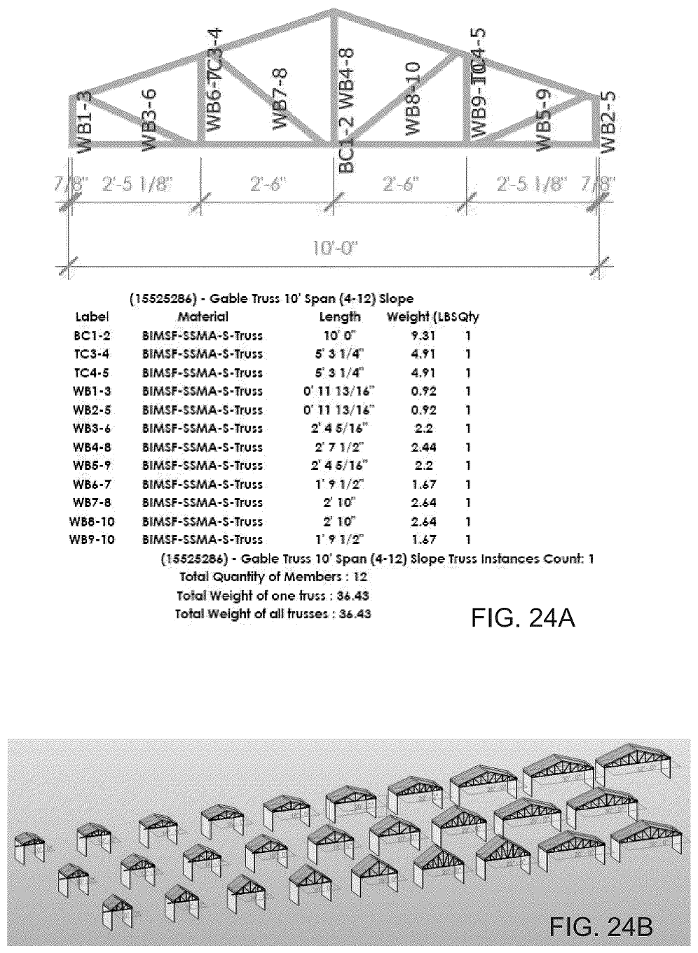

Referring to FIG. 1, the core of the computer implemented system is a database of unique pre-defined prefabricated framing components, panel frames and sub-assemblies which are standardized based on different light gauge steel criteria. The system includes a powerful analytics engine which works from the input design, accesses the database of available components and creates the panelized construction plan and a bill of materials required to complete the construction (See FIGS. 24A-24D).

The database of pre-defined, prefabricated framing components comprises multiple different types and sizes of framing components each having a defined structural data profile.

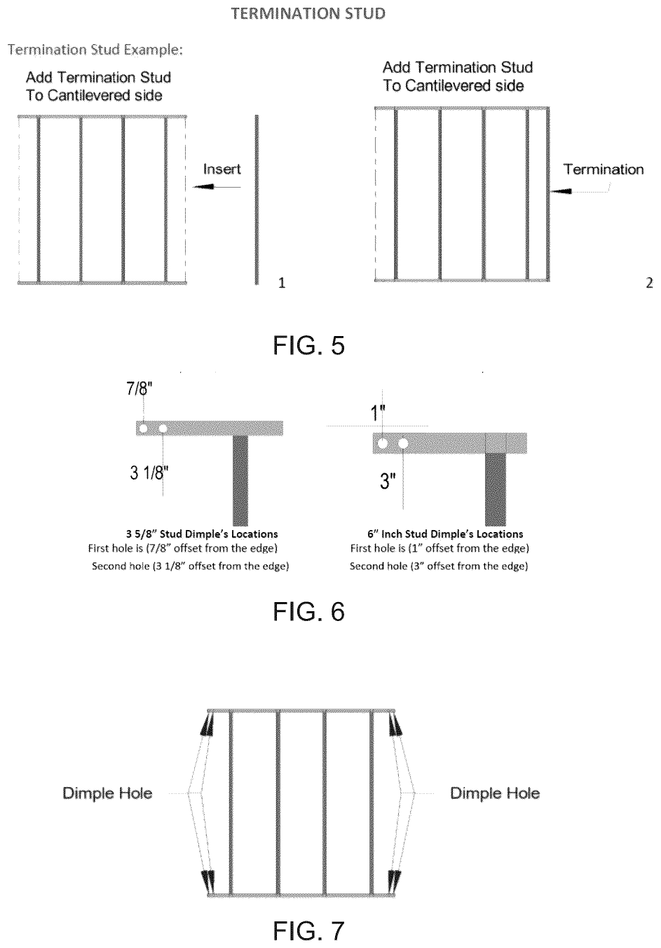

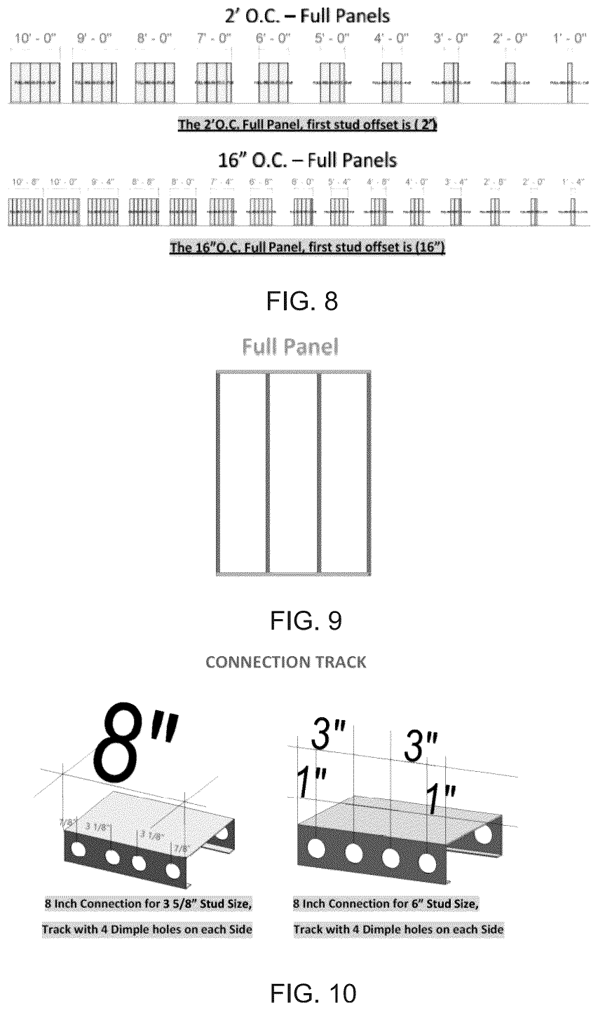

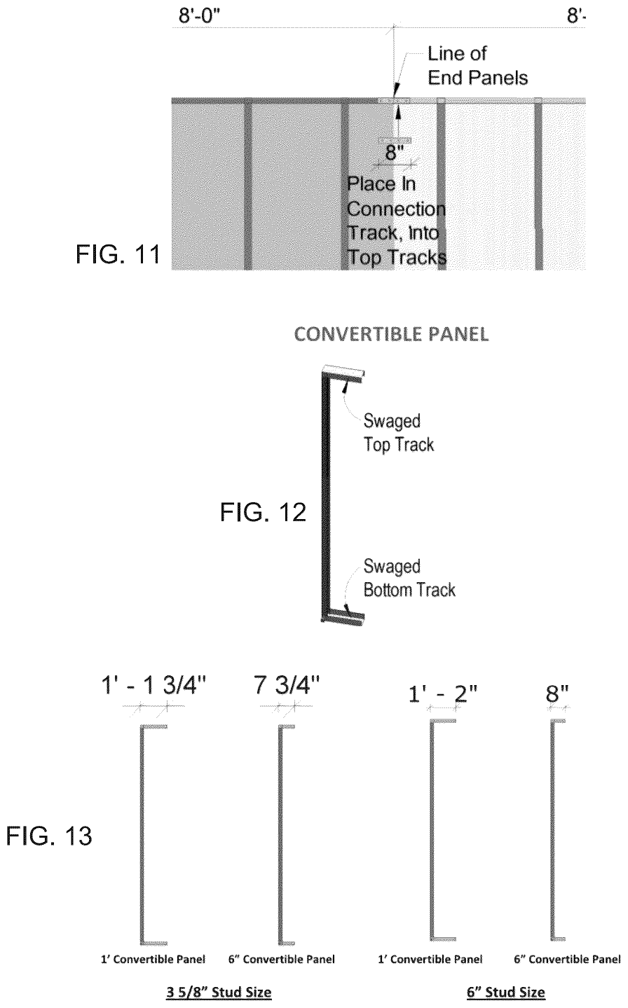

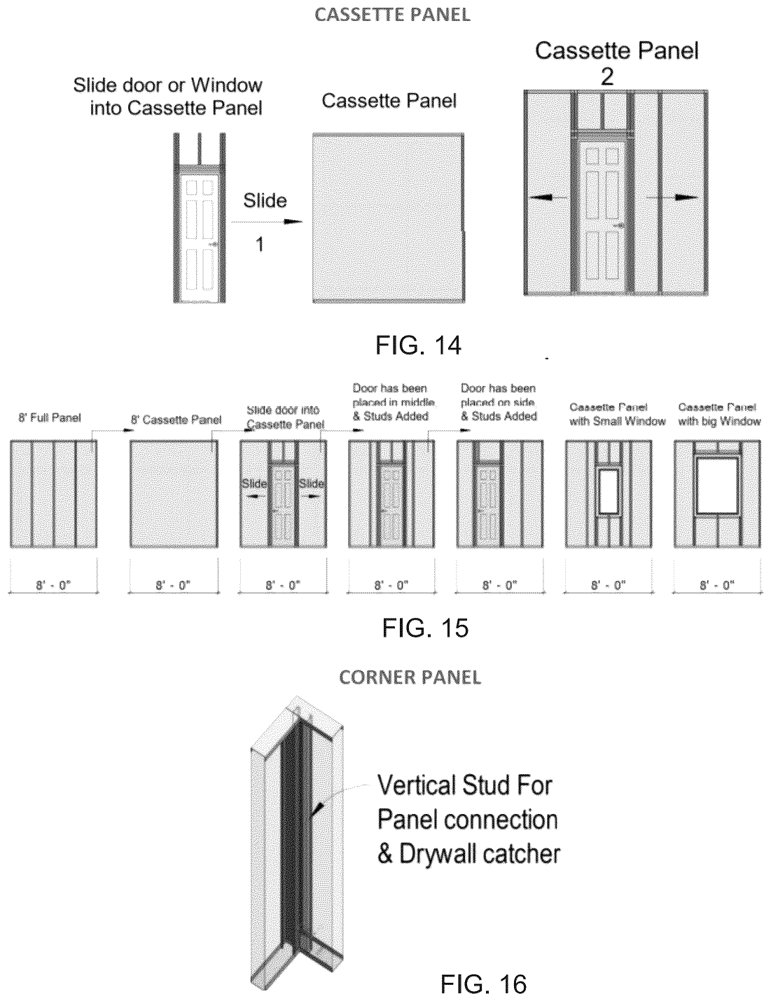

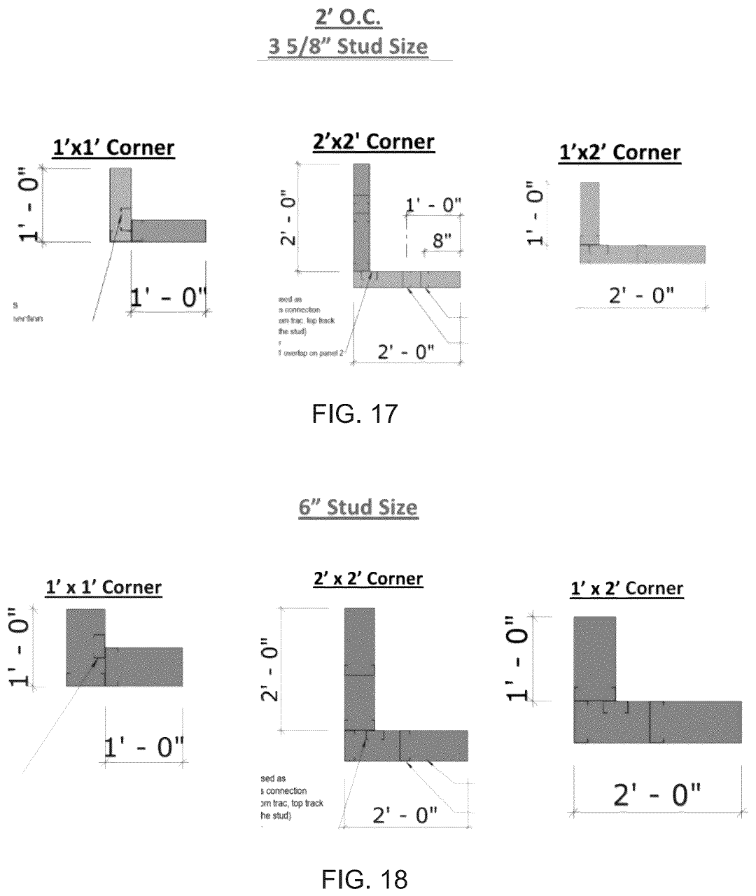

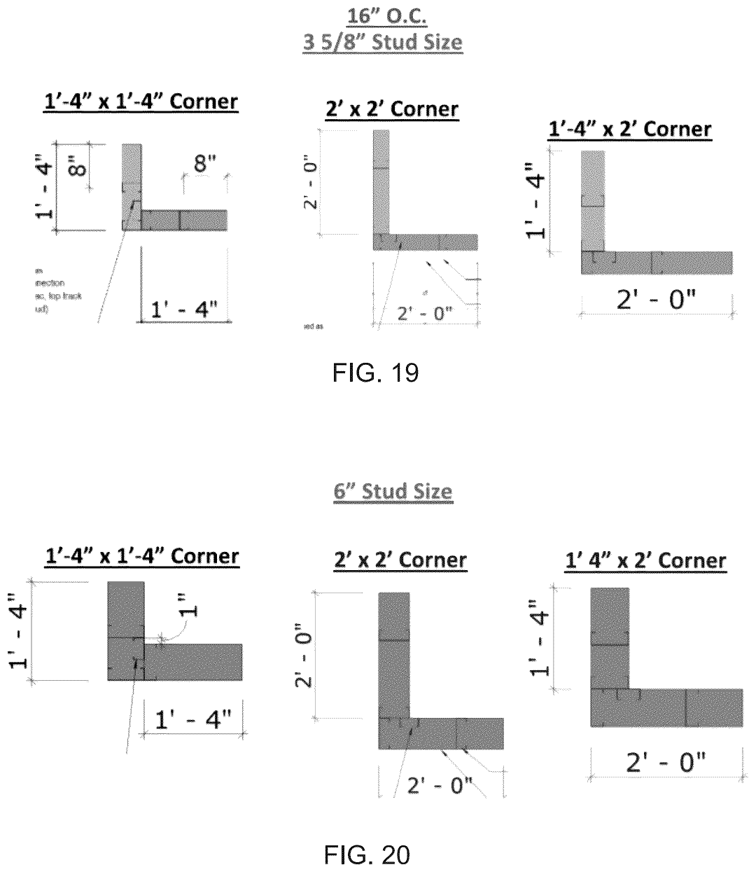

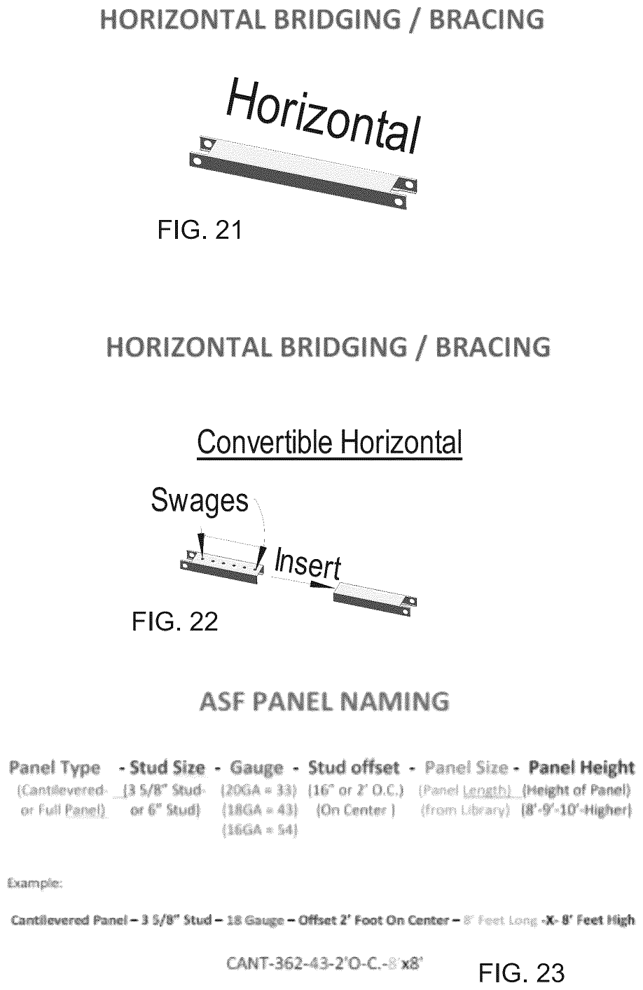

The pre-defined prefabricated framing components comprise at least the follow types of panels and components:
cantilevered panel assemblies (FIGS. 2-4),
termination studs (FIG. 5)
full panel assemblies (FIGS. 8-9),
connection tracks (FIGS. 10-11)
convertible panel assemblies (FIGS. 12-13),
cassette panels and subassemblies (FIGS. 14-15),
corner panel components/assemblies (FIGS. 16-20), and
horizontal bracing & convertible horizontal bracing (FIGS. 21-22).

The panels are generally standardized on three (3) different light gauge steel thicknesses, namely 16-gauge, 18-gauge and 20-gauge, two (2) different on-center spacings, 16″ on center and 24″ (2 Ft) on center, as well as two (2) different stud sizes, namely 3⅝″ and 6″.

Thereafter, the panel assemblies are standardized on height (8 ft, 9 ft, and 10 ft), and broken down into panels at 1-foot increments for the two-foot on center panel series (1×8, 2×8 etc.), and 8-inch increments for the sixteen-inch on center panel series (See also Appendix A).

Corner frame assemblies are standardized on 12″ (1 foot), 16″, 24″ (2 foot) lengths.

The use of 3 different gauges and 2 different spacings provides the system with the ability to frame successive upper floors of a building with lighter steel components which do not need to carry as heavy a load as the lower floors. This simple building criteria can significantly reduce material costs. Accordingly, each set of described panels is reproduced in three separate gauges for consistent design and implementation.

Referring to FIGS. 2 and 3, the cantilevered panels comprise horizontal top and bottom tracks with a plurality of vertical studs secured therebetween at predefined spacing. The cantilevered panels may be open on both sides (in-line) or only one side (termination) and are used in exterior, or interior wall framing. In-line panels have even number foot lengths (2, 4, 6 etc.) and are open/cantilevered on both sides. Termination panels have odd number foot lengths (1, 3, 5 etc.) and are open/cantilevered on only one side.

Any cantilevered side can become a termination side if needed, by inserting a vertical termination stud on the end of the cantilevered side (See FIG. 5). Dimple holes are provided at the exposed terminal ends of the cantilevered top and bottom panel tracks (See FIG. 6).

Referring to FIGS. 8 and 9, full panels are closed on both end and are typically used for interior walls.

An exemplary naming convention for the cantilevered and full panels is set forth in FIG. 23, while an exemplary (but not exhaustive) list of proposed framing panels is set forth within Appendix A (8/9/10 foot panel breakdowns).

Referring to FIGS. 6, 7, 10, 11, cantilevered panels are connected at their top and bottom tracks by universal connection tracks (See FIG. 10) sized for the 3 different gauges and two different stud sizes.

The cantilevered panel tracks and sidewalls of said universal connection tracks each include mating dimple holes for alignment, fastening, and to host a termination/end stud wherever needed to terminate the end of the panel. All cantilevered track sides include two spaced dimple holes (4 holes total) for the top and bottom tracks to receive and mate with the 8 inch connection tracks. For the 3⅝ inch stud configuration, the first hole is ⅞ inch offset from the edge and the second hole is 3⅛ inch offset from the edge (see FIG. 6). For the 6 inch stud configuration, the first hole is 1 inch offset from the edge and the second hole is 3 inch offset from the edge (see also FIG. 6).

Termination panels can be used only on the end of building wall to connect/intersect with an end wall. Termination panels can't be used between two inline panels. Between or after corners, only in-line panels should be used and termination panels can't be used. All exterior walls should be in-line panels when running between corners.

Full panels should be used for single interior walls within 1-10 foot in length and within system standard sizes. Full panels should also be used when terminating panels from two ends.

Referring to FIGS. 12 and 13, the system may further comprise convertible panels which interfit with open ends of the cantilevered panels to create closed ends where needed. Convertible panels are an extension panel comprising 3 members, namely top and bottom tracks an a single vertical stud and one end. The convertible panels are used to reach desired “odd” lengths which are not within the standard system sizes. Convertible panels are typically two sizes comprising a 6 inch version and a 1 foot version, for each stud size.

For 3⅝ stud size, the actual size of the 6 inch convertible panel is 7¾ inch to extend the panel from ½ inch up to 6 inches. The actual size of the 1 foot convertible panel is 13¾ inches to extend the panel from ½ inch up to 1 foot.

For 6 inch stud size, the actual size of the 6 inch convertible panel is 8 inch to extend the panel from ½ inch up to 6 inches. The actual size of the 1 foot convertible panel is 14 inches to extend the panel from ½ inch up to 1 foot. Each convertible panel track has an end dimple hole and the top and bottom tracks are swaged so that they can slide onto the open ends of cantilevered panels. The additional length is provided to provide alignment space for the dimple holes of each panel to connect.

Referring to FIGS. 14 and 15, the pre-defined prefabricated framing components may further comprise a plurality of cassette panels which are structurally adaptable to easily integrate doors and windows framing with its assembled headers into the framing panels. Cassette panels are frame panels without vertical stud offsets, but dimple holes are provided for connections where needed for 16 inch on center and 2 foot on center spacing. The top and bottom tracks are lips off C-shaped tracks which allow any stud, wall or window assembly with needed headers and foots to be slid into a required location within the cassette panel. Studs are added at appropriate spacing locations. The cassette panel is open from one side and then a terminal stud is added at the end to close off the panel.

As can be seen in FIG. 15, an exemplary 8-foot full panel is converted into a cassette by removing the internal vertical studs and sliding a door or window into the required location. Internal vertical studs, and footers are then installed as needed to fill the framing panel back out as it would normally be framed on site.

Referring to FIGS. 16-20, the system may further comprise a plurality of corner panel configurations. Corner panels are two small individual panels that are connected together as a single unit with a 3^{rd} vertical stud in a standard 3 stud corner configuration. All corner panels have cantilevered ends, and all panels between corner panels need to be inline panels.

For shear walls, horizontal bracing may be used for blocking (See FIG. 21). Horizontal bracing for blocking can be assembled on site, or offsite. Additionally convertible bracing can be utilized to the end of the panel spacing (See FIG. 21).

Referring to FIGS. 24A-24B, the system may further include pre-defined roof trusses with progressive pitches from 4-12 to 6-12 to 8-12 pitches and in progressive spans from 10 to 32 feet.

Each panel, component and truss of the system is specifically pre-engineered for a particular load, span and weight bearing capability, meaning that a structural engineer has analyzed the panel and component material data for structural stability and use.

As organized in the database each component is defined with a unique structural data profile which comprises a data set including at least a stud width, a stud wall thickness (gauge), an on-center dimension, a panel height and a panel width Likewise, the corner components are defined similarly with the same data set.

In all, there may be 100's or 1000's of distinct framing panels, components and trusses which make up the complete component system.

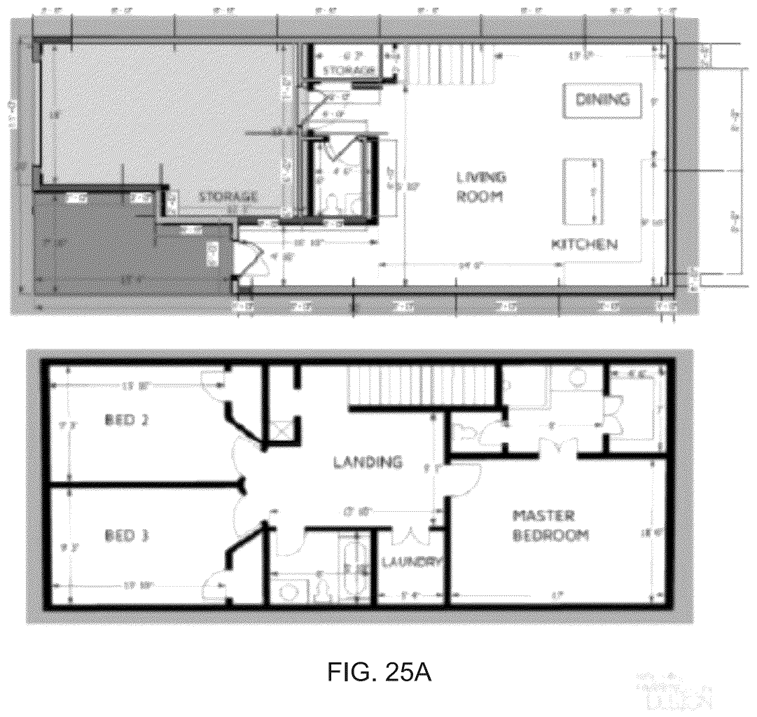

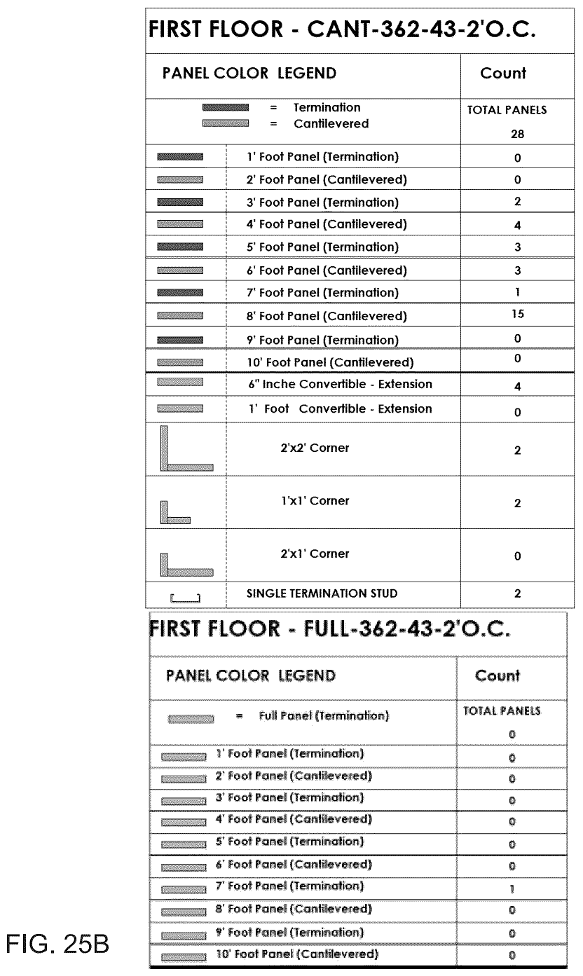

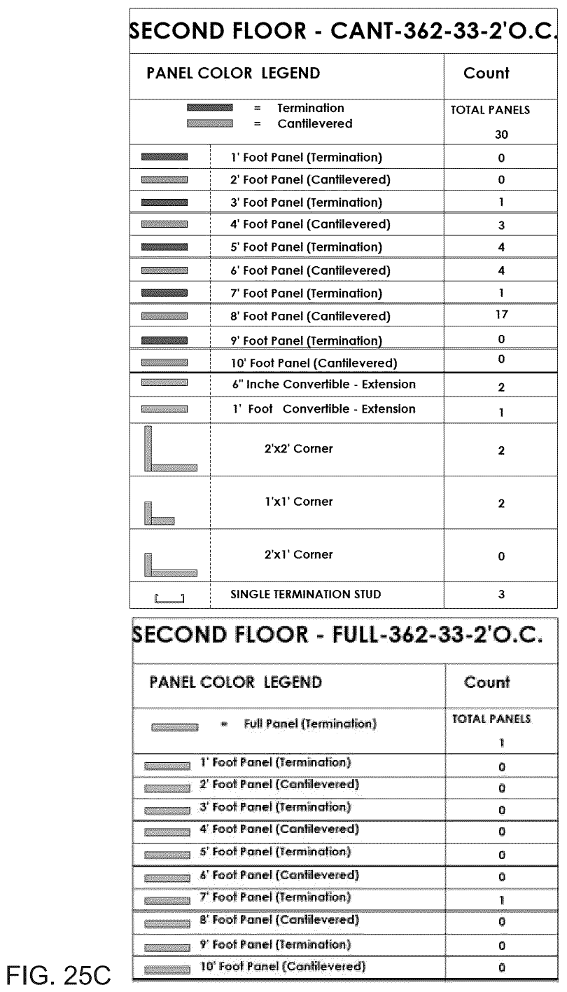

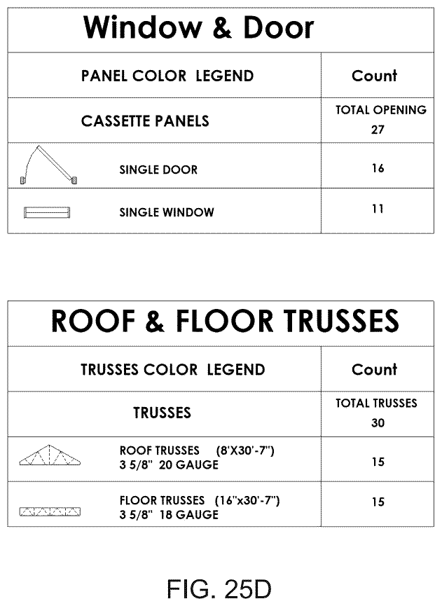

Once a design has been completed in a suitable CAD program, the system will catalogue each of the required panels and components and create a bill of materials (BOM) with appropriate panel types, number and costs to complete the design. From the BOM, the builder can have these standardized panels and components built off-site and then shipped to the site for assembly. All like panels can be built at the same time for consistency, repeatability and cost savings. See FIGS. 25A-25D for an exemplary project plan and BOM created from the system.

As noted above, the exemplary system may be implemented as a plugin module for a 3D CAD building system, such as AutoDesk Revit, which can be used to create a building design as a new plan, or to import an existing plan and convert it into a panelized plan.

An exemplary methodology for creating a panelized system may comprise:
placing the Customer's Plans In Revit with SCALE correction—(Building file from customer can be PDF, AutoCAD, Scanned PDF like JPG);
scanning the walls and openings out of the client plan;
converting the 2D plan to 3D Revit walls based on engineering inputs (stud size and spacing);
panelize the Building applying the present panelization system as described;
create panels schedules with all Cost & BIM information generated from the model (such as price, number of panels, panel use, weight, linear foot of the use material) (Revit Schedules or other format that it can be converted to common format, to use for future analysis);
converting the 3D walls to 3D Structural Framing (Using described stud size/panels) benefit (for visualizations—& MEP, clash detection); and
configuring roof & floor trusses, stairs, and other non standard elements.

FIGS. 26A-26E illustrate exemplary screen shots of an exemplary design process and resulting outputs. A single exterior wall plan is illustrated. In FIG. 26A, exterior wall boundaries are drawn into a conventional plan. An enlarged view (FIG. 26B) shows the wall automatically broken down into corner components and multiple wall panels to fit the length of the wall boundaries. Turning to FIG. 26C, a single wall panel can be selected and the panel properties can be seen in the left hand window (enlarged FIG. 26D). Once the plan is completed, the system allows the user to generate a bill of materials for construction of the required panel assemblies (FIG. 26E).

Likewise the system allows the import of existing plans which can be copied and analyzed for panelization allowing the system to be used for plan completed in other systems (See FIGS. 27A-27B).

Once imported the system will panelize the structure, suggest dimensional changes that may make the system compliant with the standard size panels and create schedules for construction (see right hand panel in FIG. 27B).

While the present disclosure focuses on light gauge steel framing, the same concepts could be similarly applied to wood framing with some minor accommodations.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

### APPENDIX A

Panel Database Breakdown
8′ Height Panels
A. 2′ Foot on Center
A.1—Cantilevered Panels
1—CANT-362-33-2′O.C.
   CANT-362-33-2′O-C.-1′×8′
   CANT-362-33-2′O-C.-2′×8′
   CANT-362-33-2′O-C.-3′×8′
   CANT-362-33-2′O-C.-4′×8′
   CANT-362-33-2′O-C.-5′×8′
   CANT-362-33-2′O-C.-6′×8′
   CANT-362-33-2′O-C.-7′×8′
   CANT-362-33-2′O-C.-8′×8′
   CANT-362-33-2′O-C.-9′×8′
   CANT-362-33-2′O-C.-10′×8′
2—CANT-362-43-2′O.C.
   CANT-362-43-2′O-C.-1′×8′
   CANT-362-43-2′O-C.-2′×8′
   CANT-362-43-2′O-C.-3′×8′
   CANT-362-43-2′O-C.-4′×8′
   CANT-362-43-2′O-C.-5′×8′
   CANT-362-43-2′O-C.-6′×8′
   CANT-362-43-2′O-C.-7′×8′
   CANT-362-43-2′O-C.-8′×8′
   CANT-362-43-2′O-C.-9′×8′
   CANT-362-43-2′O-C.-10′×8′
3—CANT-600-43-2′O.C.
   CANT-362-43-2′O-C.-1′×8′
   CANT-600-43-2′O-C.-2′×8′
   CANT-600-43-2′O-C.-3′×8′
   CANT-600-43-2′O-C.-4′×8′
   CANT-600-43-2′O-C.-5′×8′
   CANT-600-43-2′O-C.-6′×8′
   CANT-600-43-2′O-C.-7′×8′
   CANT-600-43-2′O-C.-8′×8′
   CANT-600-43-2′O-C.-9′×8′
   CANT-600-43-2′O-C.-10′×8′
4—CANT-600-54-2′O.C.
   CANT-600-54-2′O-C.-2′×8′
   CANT-600-54-2′O-C.-3′×8′
   CANT-600-54-2′O-C.-4′×8′
   CANT-600-54-2′O-C.-5′×8′
   CANT-600-54-2′O-C.-6′×8′
   CANT-600-54-2′O-C.-7′×8′
   CANT-600-54-2′O-C.-8′×8′
   CANT-600-54-2′O-C.-9′×8′
   CANT-600-54-2′O-C.-10′×8′
A.2—Full Panel
1—FULL-362-33-2′O.C.
   FULL-362-33-16-O.C.-1′×8′
   FULL-362-33-16-O.C.-2′×8′
   FULL-362-33-16-O.C.-3′×8′
   FULL-362-33-16-O.C.-4′×8′
   FULL-362-33-16-O.C.-5′×8′
   FULL-362-33-16-O.C.-6′×8′
   FULL-362-33-16-O.C.-7′×8′
   FULL-362-33-16-O.C.-8′×8′
   FULL-362-33-16-O.C.-9′×8′
   FULL-362-33-16-O.C.-10′×8′
2—FULL-362-43-2′O.C.
   FULL-362-43-16-O.C.-1′×8′
   FULL-362-43-16-O.C.-2′×8′
   FULL-362-43-16-O.C.-3′×8′
   FULL-362-43-16-O.C.-4′×8′
   FULL-362-43-16-O.C.-5′×8′
   FULL-362-43-16-O.C.-6′×8′
   FULL-362-43-16-O.C.-7′×8′
   FULL-362-43-16-O.C.-8′×8′
   FULL-362-43-16-O.C.-9′×8′
   FULL-362-43-16-O.C.-10′×8′
3—FULL-600-43-2′O.C
   FULL-600-43-16-O.C.-1′×8′
   FULL-600-43-16-O.C.-2′×8′
   FULL-600-43-16-O.C.-3′×8′
   FULL-600-43-16-O.C.-4′×8′
   FULL-600-43-16-O.C.-5′×8′
   FULL-600-43-16-O.C.-6′×8′
   FULL-600-43-16-O.C.-7′×8′
   FULL-600-43-16-O.C.-8′×8′
   FULL-600-43-16-O.C.-9′×8′
   FULL-600-43-16-O.C.-10′×8′
4—FULL-600-54-2′O-C
   FULL-600-54-16-O.C.-1′×8′
   FULL-600-54-16-O.C.-2′×8′
   FULL-600-54-16-O.C.-3′×8′
   FULL-600-54-16-O.C.-4′×8′
   FULL-600-54-16-O.C.-5′×8′
   FULL-600-54-16-O.C.-6′×8′
   FULL-600-54-16-O.C.-7′×8′
   FULL-600-54-16-O.C.-8′×8′
   FULL-600-54-16-O.C.-9′×8′
   FULL-600-54-16-O.C.-10′×8′
B. 16″ Inch On Center
B.1—Cantilevered Panels
1—CANT-362-33-16-O.C.
   CANT-362-33-16-O-C--1′-4-×8′
   CANT-362-33-16-O-C--2′-8-×8′
   CANT-362-33-16-O-C--2′×8′
   CANT-362-33-16-O-C--3′-4-×8′
   CANT-362-33-16-O-C--4′×8′
   CANT-362-33-16-O-C--4′-8-×8′
   CANT-362-33-16-O-C--5′-4-×8′
   CANT-362-33-16-O-C--6′×8′
   CANT-362-33-16-O-C--6′-8-×8′
   CANT-362-33-16-O-C--7′-4-×8′
   CANT-362-33-16-O-C--8′×8′
   CANT-362-33-16-O-C--8′-8-×8′
   CANT-362-33-16-O-C--9′-4-×8′
   CANT-362-33-16-O-C--10′×8′
   CANT-362-33-16-O-C--10′-8-×8′
2—CANT-362-43-16-O.C.
   CANT-362-43-16-O-C--1′-4-×8′
   CANT-362-43-16-O-C--2′-8-×8′
   CANT-362-43-16-O-C--2′×8′
   CANT-362-43-16-O-C--3′-4-×8′
   CANT-362-43-16-O-C--4′×8′
   CANT-362-43-16-O-C--4′-8-×8′
   CANT-362-43-16-O-C--5′-4-×8′
   CANT-362-43-16-O-C--6′×8′
   CANT-362-43-16-O-C--6′-8-×8′
   CANT-362-43-16-O-C--7′-4-×8′
   CANT-362-43-16-O-C--8′×8′
   CANT-362-43-16-O-C--8′-8-×8′
   CANT-362-43-16-O-C--9′-4-×8′
   CANT-362-43-16-O-C--10′×8′
   CANT-362-43-16-O-C--10′-8-×8′
3—CANT-600-43-16-O.C.
   CANT-600-43-16-O-C--1′-4-×8′
   CANT-600-43-16-O-C--2′-8-×8′
   CANT-600-43-16-O-C--2′×8′
   CANT-600-43-16-O-C--3′-4-×8′
   CANT-600-43-16-O-C--4′×8′
   CANT-600-43-16-O-C--4′-8-×8′
   CANT-600-43-16-O-C--5′-4-×8′
   CANT-600-43-16-O-C--6′×8′
   CANT-600-43-16-O-C--6′-8-×8′
   CANT-600-43-16-O-C--7′-4-×8′
   CANT-600-43-16-O-C--8′×8′
   CANT-600-43-16-O-C--8′-8-×8′
   CANT-600-43-16-O-C--9′-4-×8′
   CANT-600-43-16-O-C--10′×8′
   CANT-600-43-16-O-C--10′-8-×8′
4—CANT-600-54-16-O.C.
   CANT-600-54-16-O-C--1′-4-×8′
   CANT-600-54-16-O-C--2′-8-×8′
   CANT-600-54-16-O-C--2′×8′
   CANT-600-54-16-O-C--3′-4-×8′
   CANT-600-54-16-O-C--4′×8′
   CANT-600-54-16-O-C--4′-8-×8′
   CANT-600-54-16-O-C--5′-4-×8′
   CANT-600-54-16-O-C--6′×8′
   CANT-600-54-16-O-C--6′-8-×8′
   CANT-600-54-16-O-C--7′-4-×8′
   CANT-600-54-16-O-C--8′×8′
   CANT-600-54-16-O-C--8′-8-×8′
   CANT-600-54-16-O-C--9′-4-×8′
   CANT-600-54-16-O-C--10′×8′
   CANT-600-54-16-O-C--10′-8-×8′
B.2—Full Panels
1—FULL-362-33-16-O.C.
   FULL-362-33-16-O-C--1′-4-×8′
   FULL-362-33-16-O-C--2′-8-×8′
   FULL-362-33-16-O-C--2′×8′
   FULL-362-33-16-O-C--3′-4-×8′
   FULL-362-33-16-O-C--4′×8′
   FULL-362-33-16-O-C--4′-8-×8′
   FULL-362-33-16-O-C--5′-4-×8′
   FULL-362-33-16-O-C--6′×8′
   FULL-362-33-16-O-C--6′-8-×8′
   FULL-362-33-16-O-C--7′-4-×8′
   FULL-362-33-16-O-C--8′×8′
   FULL-362-33-16-O-C--8′-8-×8′
   FULL-362-33-16-O-C--9′-4-×8′
   FULL-362-33-16-O-C--10′×8′
   FULL-362-33-16-O-C--10′-8-×8′
2—FULL-362-43-16-O.C.
   FULL-362-43-16-O-C--1′-4-×8′
   FULL-362-43-16-O-C--2′-8-×8′
   FULL-362-43-16-O-C--2′×8′
   FULL-362-43-16-O-C--3′-4-×8′
   FULL-362-43-16-O-C--4′×8′
   FULL-362-43-16-O-C--4′-8-×8′
   FULL-362-43-16-O-C--5′-4-×8′
   FULL-362-43-16-O-C--6′×8′
   FULL-362-43-16-O-C--6′-8-×8′
   FULL-362-43-16-O-C--7′-4-×8′
   FULL-362-43-16-O-C--8′×8′
   FULL-362-43-16-O-C--8′-8-×8′
   FULL-362-43-16-O-C--9′-4-×8′
   FULL-362-43-16-O-C--10′×8′
   FULL-362-43-16-O-C--10′-8-×8′
3—FULL-600-43-16-O.C.
   FULL-600-43-16-O-C--1′-4-×8′
   FULL-600-43-16-O-C--2′-8-×8′
   FULL-600-43-16-O-C--2′×8′
   FULL-600-43-16-O-C--3′-4-×8′
   FULL-600-43-16-O-C--4′×8′
   FULL-600-43-16-O-C--4′-8-×8′
   FULL-600-43-16-O-C--5′-4-×8′
   FULL-600-43-16-O-C--6′×8′
   FULL-600-43-16-O-C--6′-8-×8′
   FULL-600-43-16-O-C--7′-4-×8′
   FULL-600-43-16-O-C--8′×8′
   FULL-600-43-16-O-C--8′-8-×8′
   FULL-600-43-16-O-C--9′-4-×8′
   FULL-600-43-16-O-C--10′×8′
   FULL-600-43-16-O-C--10′-8-×8′
4—FULL-600-54-16-O.C.
   FULL-600-54-16-O-C--1′-4-×8′
   FULL-600-54-16-O-C--2′-8-×8′
   FULL-600-54-16-O-C--2′×8′
   FULL-600-54-16-O-C--3′-4-×8′
   FULL-600-54-16-O-C--4′×8′
   FULL-600-54-16-O-C--4′-8-×8′
   FULL-600-54-16-O-C--5′-4-×8′
   FULL-600-54-16-O-C--6′×8′
   FULL-600-54-16-O-C--6′-8-×8′
   FULL-600-54-16-O-C--7′-4-×8′
   FULL-600-54-16-O-C--8′×8′
   FULL-600-54-16-O-C--8′-8-×8′
   FULL-600-54-16-O-C--9′-4-×8′
   FULL-600-54-16-O-C--10′×8′
   FULL-600-54-16-O-C--10′-8-×8′
9′ Height Panels
A. 2′ Foot on Center
A.1—Cantilevered Panels
1—CANT-362-33-2′O.C.
   CANT-362-33-2′O-C.-1′×9′
   CANT-362-33-2′O-C.-2′×9′
   CANT-362-33-2′O-C.-3′×9′
   CANT-362-33-2′O-C.-4′×9′
   CANT-362-33-2′O-C.-5′×9′
   CANT-362-33-2′O-C.-6′×9′
   CANT-362-33-2′O-C.-7′×9′
   CANT-362-33-2′O-C.-8′×9′
   CANT-362-33-2′O-C.-9′×9′
   CANT-362-33-2′O-C.-10′×9′
2—CANT-362-43-2′O.C.
   CANT-362-43-2′O-C.-1′×9′
   CANT-362-43-2′O-C.-2′×9′
   CANT-362-43-2′O-C.-3′×9′
   CANT-362-43-2′O-C.-4′×9′
   CANT-362-43-2′O-C.-5′×9′
   CANT-362-43-2′O-C.-6′×9′
   CANT-362-43-2′O-C.-7′×9′
   CANT-362-43-2′O-C.-8′×9′
   CANT-362-43-2′O-C.-9′×9′
   CANT-362-43-2′O-C.-10′×9′
3—CANT-600-43-2′O.C.
   CANT-362-43-2′O-C.-1′×9′
   CANT-600-43-2′O-C.-2′×9′
   CANT-600-43-2′O-C.-3′×9′
   CANT-600-43-2′O-C.-4′×9′
   CANT-600-43-2′O-C.-5′×9′
   CANT-600-43-2′O-C.-6′×9′
   CANT-600-43-2′O-C.-7′×9′
   CANT-600-43-2′O-C.-8′×9′
   CANT-600-43-2′O-C.-9′×9′
   CANT-600-43-2′O-C.-10′×9′
4—CANT-600-54-2′O.C.
   CANT-600-54-2′O-C.-2′×9′
   CANT-600-54-2′O-C.-3′×9′
   CANT-600-54-2′O-C.-4′×9′
   CANT-600-54-2′O-C.-5′×9′
   CANT-600-54-2′O-C.-6′×9′
   CANT-600-54-2′O-C.-7′×9′
   CANT-600-54-2′O-C.-8′×9′
   CANT-600-54-2′O-C.-9′×9′
   CANT-600-54-2′O-C.-10′×9′
A.2—Full Panel
1—FULL-362-33-2′O.C.
   FULL-362-33-16-O.C.-1′×9′
   FULL-362-33-16-O.C.-2′×9′
   FULL-362-33-16-O.C.-3′×9′
   FULL-362-33-16-O.C.-4′×9′
   FULL-362-33-16-O.C.-5′×9′
   FULL-362-33-16-O.C.-6′×9′
   FULL-362-33-16-O.C.-7′×9′
   FULL-362-33-16-O.C.-8′×9′
   FULL-362-33-16-O.C.-9′×9′
   FULL-362-33-16-O.C.-10′×9′
2—FULL-362-43-2′O.C.
   FULL-362-43-16-O.C.-1′×9′
   FULL-362-43-16-O.C.-2′×9′
   FULL-362-43-16-O.C.-3′×9′
   FULL-362-43-16-O.C.-4′×9′
   FULL-362-43-16-O.C.-5′×9′
   FULL-362-43-16-O.C.-6′×9′
   FULL-362-43-16-O.C.-7′×9′
   FULL-362-43-16-O.C.-8′×9′
   FULL-362-43-16-O.C.-9′×9′
   FULL-362-43-16-O.C.-10′×9′
3—FULL-600-43-2′O.C
   FULL-600-43-16-O.C.-1′×9′
   FULL-600-43-16-O.C.-2′×9′
   FULL-600-43-16-O.C.-3′×9′
   FULL-600-43-16-O.C.-4′×9′
   FULL-600-43-16-O.C.-5′×9′
   FULL-600-43-16-O.C.-6′×9′
   FULL-600-43-16-O.C.-7′×9′
   FULL-600-43-16-O.C.-8′×9′
   FULL-600-43-16-O.C.-9′×9′
   FULL-600-43-16-O.C.-10′×9′
4—FULL-600-54-2′O-C
   FULL-600-54-16-O.C.-1′×9′
   FULL-600-54-16-O.C.-2′×9′
   FULL-600-54-16-O.C.-3′×9′
   FULL-600-54-16-O.C.-4′×9′
   FULL-600-54-16-O.C.-5′×9′
   FULL-600-54-16-O.C.-6′×9′
   FULL-600-54-16-O.C.-7′×9′
   FULL-600-54-16-O.C.-8′×9′
   FULL-600-54-16-O.C.-9′×9′
   FULL-600-54-16-O.C.-10′×9′
B. 16″ Inch On Center
B.1—Cantilevered Panels
1—CANT-362-33-16-O.C.
   CANT-362-33-16-O-C--1′-4-×9′
   CANT-362-33-16-O-C--2′-8-×9′
   CANT-362-33-16-O-C--2′×9′
   CANT-362-33-16-O-C--3′-4-×9′
   CANT-362-33-16-O-C--4′×9′
   CANT-362-33-16-O-C--4′-8-×9′
   CANT-362-33-16-O-C--5′-4-×9′
   CANT-362-33-16-O-C--6′×9′
   CANT-362-33-16-O-C--6′-8-×9′
   CANT-362-33-16-O-C--7′-4-×9′
   CANT-362-33-16-O-C-8′×9′
   CANT-362-33-16-O-C--8′-8-×9′
   CANT-362-33-16-O-C--9′-4-×9′
   CANT-362-33-16-O-C--10′×9′
   CANT-362-33-16-O-C--10′-8-×9′
2—CANT-362-43-16-O.C.
   CANT-362-43-16-O-C--1′-4-×9′
   CANT-362-43-16-O-C--2′-8-×9′
   CANT-362-43-16-O-C--2′×9′
   CANT-362-43-16-O-C--3′-4-×9′
   CANT-362-43-16-O-C--4′×9′
   CANT-362-43-16-O-C--4′-8-×9′
   CANT-362-43-16-O-C--5′-4-×9′
   CANT-362-43-16-O-C--6′×9′
   CANT-362-43-16-O-C--6′-8-×9′
   CANT-362-43-16-O-C--7′-4-×9′
   CANT-362-43-16-O-C--8′×9′
   CANT-362-43-16-O-C--8′-8-×9′
   CANT-362-43-16-O-C--9′-4-×9′
   CANT-362-43-16-O-C--10′×9′
   CANT-362-43-16-O-C--10′-8-×9′
3—CANT-600-43-16-O.C.
   CANT-600-43-16-O-C--1′-4-×9′
   CANT-600-43-16-O-C--2′-8-×9′
   CANT-600-43-16-O-C--2′×9′
   CANT-600-43-16-O-C--3′-4-×9′
   CANT-600-43-16-O-C--4′×9′
   CANT-600-43-16-O-C--4′-8-×9′
   CANT-600-43-16-O-C--5′-4-×9′
   CANT-600-43-16-O-C--6′×9′
   CANT-600-43-16-O-C--6′-8-×9′
   CANT-600-43-16-O-C--7′-4-×9′
   CANT-600-43-16-O-C--8′×9′
   CANT-600-43-16-O-C--8′-8-×9′
   CANT-600-43-16-O-C--9′-4-×9′
   CANT-600-43-16-O-C--10′×9′
   CANT-600-43-16-O-C--10′-8-×9′
4—CANT-600-54-16-O.C.
   CANT-600-54-16-O-C--1′-4-×9′
   CANT-600-54-16-O-C--2′-8-×9′
   CANT-600-54-16-O-C--2′×9′
   CANT-600-54-16-O-C--3′-4-×9′
   CANT-600-54-16-O-C--4′×9′
   CANT-600-54-16-O-C--4′-8-×9′
   CANT-600-54-16-O-C--5′-4-×9′
   CANT-600-54-16-O-C--6′×9′
   CANT-600-54-16-O-C--6′-8-×9′
   CANT-600-54-16-O-C--7′-4-×9′
   CANT-600-54-16-O-C--8′×9′
   CANT-600-54-16-O-C--8′-8-×9′
   CANT-600-54-16-O-C--9′-4-×9′
   CANT-600-54-16-O-C--10′×9′
   CANT-600-54-16-O-C--10′-8-×9′
B.2—Full Panels
1—FULL-362-33-16-O.C.
   FULL-362-33-16-O-C--1′-4-×9′
   FULL-362-33-16-O-C--2′-8-×9′
   FULL-362-33-16-O-C--2′×9′
   FULL-362-33-16-O-C--3′-4-×9′
   FULL-362-33-16-O-C--4′×9′
   FULL-362-33-16-O-C--4′-8-×9′
   FULL-362-33-16-O-C--5′-4-×9′
   FULL-362-33-16-O-C--6′×9′
   FULL-362-33-16-O-C--6′-8-×9′
   FULL-362-33-16-O-C--7′-4-×9′
   FULL-362-33-16-O-C--8′×9′
   FULL-362-33-16-O-C--8′-8-×9′
   FULL-362-33-16-O-C--9′-4-×9′
   FULL-362-33-16-O-C--10′×9′
   FULL-362-33-16-O-C--10′-8-×9′
2—FULL-362-43-16-O.C.
   FULL-362-43-16-O-C--1′-4-×9′
   FULL-362-43-16-O-C--2′-8-×9′
   FULL-362-43-16-O-C--2′×9′
   FULL-362-43-16-O-C--3′-4-×9′
   FULL-362-43-16-O-C--4′×9′
   FULL-362-43-16-O-C--4′-8-×9′
   FULL-362-43-16-O-C--5′-4-×9′
   FULL-362-43-16-O-C--6′×9′
   FULL-362-43-16-O-C--6′-8-×9′
   FULL-362-43-16-O-C--7′-4-×9′
   FULL-362-43-16-O-C--8′×9′
   FULL-362-43-16-O-C--8′-8-×9′
   FULL-362-43-16-O-C--9′-4-×9′
   FULL-362-43-16-O-C--10′×9′
   FULL-362-43-16-O-C--10′-8-×9′
3—FULL-600-43-16-O.C.
   FULL-600-43-16-O-C--1′-4-×9′
   FULL-600-43-16-O-C--2′-8-×9′
   FULL-600-43-16-O-C--2′×9′
   FULL-600-43-16-O-C--3′-4-×9′
   FULL-600-43-16-O-C--4′×9′
   FULL-600-43-16-O-C--4′-8-×9′
   FULL-600-43-16-O-C--5′-4-×9′
   FULL-600-43-16-O-C--6′×9′
   FULL-600-43-16-O-C--6′-8-×9′
   FULL-600-43-16-O-C--7′-4-×9′
   FULL-600-43-16-O-C--8′×9′
   FULL-600-43-16-O-C--8′-8-×9′
   FULL-600-43-16-O-C--9′-4-×9′
   FULL-600-43-16-O-C--10′×9′
   FULL-600-43-16-O-C--10′-8-×9′
4—FULL-600-54-16-O.C.
   FULL-600-54-16-O-C--1′-4-×9′
   FULL-600-54-16-O-C--2′-8-×9′
   FULL-600-54-16-O-C--2′×9′
   FULL-600-54-16-O-C--3′-4-×9′
   FULL-600-54-16-O-C--4′×9′
   FULL-600-54-16-O-C--4′-8-×9′
   FULL-600-54-16-O-C--5′-4-×9′
   FULL-600-54-16-O-C--6′×9′
   FULL-600-54-16-O-C--6′-8-×9′
   FULL-600-54-16-O-C--7′-4-×9′
   FULL-600-54-16-O-C--8′×9′
   FULL-600-54-16-O-C--8′-8-×9′
   FULL-600-54-16-O-C--9′-4-×9′
   FULL-600-54-16-O-C--10′×9′
   FULL-600-54-16-O-C--10′-8-×9′
10′ Height Panels
A. 2′ Foot on Center
A.1—Cantilevered Panels
1—CANT-362-33-2′O.C.
   CANT-362-33-2′O-C.-1′×10′
   CANT-362-33-2′O-C.-2′×10′
   CANT-362-33-2′O-C.-3′×10′
   CANT-362-33-2′O-C.-4′×10′
   CANT-362-33-2′O-C.-5′×10′
   CANT-362-33-2′O-C.-6′×10′
   CANT-362-33-2′O-C.-7′×10′
   CANT-362-33-2′O-C.-8′×10′
   CANT-362-33-2′O-C.-9′×10′
   CANT-362-33-2′O-C.-10′×10′
2—CANT-362-43-2′O.C.
   CANT-362-43-2′O-C.-1′×10′
   CANT-362-43-2′O-C.-2′×10′
   CANT-362-43-2′O-C.-3′×10′
   CANT-362-43-2′O-C.-4′×10′
   CANT-362-43-2′O-C.-5′×10′
   CANT-362-43-2′O-C.-6′×10′
   CANT-362-43-2′O-C.-7′×10′
   CANT-362-43-2′O-C.-8′×10′
   CANT-362-43-2′O-C.-9′×10′
   CANT-362-43-2′O-C.-10′×10′
3—CANT-600-43-2′O.C.
   CANT-362-43-2′O-C.-1′×10′
   CANT-600-43-2′O-C.-2′×10′
   CANT-600-43-2′O-C.-3′×10′
   CANT-600-43-2′O-C.-4′×10′
   CANT-600-43-2′O-C.-5′×10′
   CANT-600-43-2′O-C.-6′×10′
   CANT-600-43-2′O-C.-7′×10′
   CANT-600-43-2′O-C.-8′×10′
   CANT-600-43-2′O-C.-9′×10′
   CANT-600-43-2′O-C.-10′×10′
4—CANT-600-54-2′O.C.
   CANT-600-54-2′O-C.-2′×10′
   CANT-600-54-2′O-C.-3′×10′
   CANT-600-54-2′O-C.-4′×10′
   CANT-600-54-2′O-C.-5′×10′
   CANT-600-54-2′O-C.-6′×10′
   CANT-600-54-2′O-C.-7′×10′
   CANT-600-54-2′O-C.-8′×10′
   CANT-600-54-2′O-C.-9′×10′
   CANT-600-54-2′O-C.-10′×10′
A.2—Full Panel
1—FULL-362-33-2′O.C.
   FULL-362-33-16-O.C.-1′×10′
   FULL-362-33-16-O.C.-2′×10′
   FULL-362-33-16-O.C.-3′×10′
   FULL-362-33-16-O.C.-4′×10′
   FULL-362-33-16-O.C.-5′×10′
   FULL-362-33-16-O.C.-6′×10′
   FULL-362-33-16-O.C.-7′×10′
   FULL-362-33-16-O.C.-8′×10′
   FULL-362-33-16-O.C.-9′×10′
   FULL-362-33-16-O.C.-10′×10′
2—FULL-362-43-2′O.C.
   FULL-362-43-16-O.C.-1′×10′
   FULL-362-43-16-O.C.-2′×10′
   FULL-362-43-16-O.C.-3′×10′
   FULL-362-43-16-O.C.-4′×10′
   FULL-362-43-16-O.C.-5′×10′
   FULL-362-43-16-O.C.-6′×10′
   FULL-362-43-16-O.C.-7′×10′
   FULL-362-43-16-O.C.-8′×10′
   FULL-362-43-16-O.C.-9′×10′
   FULL-362-43-16-O.C.-10′×10′
3—FULL-600-43-2′O.C
   FULL-600-43-16-O.C.-1′×10′
   FULL-600-43-16-O.C.-2′×10′
   FULL-600-43-16-O.C.-3′×10′
   FULL-600-43-16-O.C.-4′×10′
   FULL-600-43-16-O.C.-5′×10′
   FULL-600-43-16-O.C.-6′×10′
   FULL-600-43-16-O.C.-7′×10′
   FULL-600-43-16-O.C.-8′×10′
   FULL-600-43-16-O.C.-9′×10′
   FULL-600-43-16-O.C.-10′×10′
4—FULL-600-54-2′O-C
   FULL-600-54-16-O.C.-1′×10′
   FULL-600-54-16-O.C.-2′×10′
   FULL-600-54-16-O.C.-3′×10′
   FULL-600-54-16-O.C.-4′×10′
   FULL-600-54-16-O.C.-5′×10′
   FULL-600-54-16-O.C.-6′×10′
   FULL-600-54-16-O.C.-7′×10′
   FULL-600-54-16-O.C.-8′×10′
   FULL-600-54-16-O.C.-9′×10′
   FULL-600-54-16-O.C.-10′×10′
B. 16″ Inch On Center
B.1—Cantilevered Panels
1—CANT-362-33-16-O.C.
   CANT-362-33-16-O-C--1′-4-×10′
   CANT-362-33-16-O-C--2′-8-×10′
   CANT-362-33-16-O-C--2′×10′
   CANT-362-33-16-O-C--3′-4-×10′
   CANT-362-33-16-O-C--4′×10′
   CANT-362-33-16-O-C--4′-8-×10′
   CANT-362-33-16-O-C--5′-4-×10′
   CANT-362-33-16-O-C--6′×10′
   CANT-362-33-16-O-C--6′-8-×10′
   CANT-362-33-16-O-C--7′-4-×10′
   CANT-362-33-16-O-C--8′×10′
   CANT-362-33-16-O-C--8′-8-×10′
   CANT-362-33-16-O-C--9′-4-×10′
   CANT-362-33-16-O-C-10′×10′
   CANT-362-33-16-O-C-10′-8-×10′
2—CANT-362-43-16-O.C.
   CANT-362-43-16-O-C--1′-4-×10′
   CANT-362-43-16-O-C--2′-8-×10′
   CANT-362-43-16-O-C--2′×10′
   CANT-362-43-16-O-C--3′-4-×10′
   CANT-362-43-16-O-C--4′×10′
   CANT-362-43-16-O-C--4′-8-×10′
   CANT-362-43-16-O-C--5′-4-×10′
   CANT-362-43-16-O-C--6′×10′
   CANT-362-43-16-O-C--6′-8-×10′
   CANT-362-43-16-O-C--7′-4-×10′
   CANT-362-43-16-O-C--8′×10′
   CANT-362-43-16-O-C--8′-8-×10′
   CANT-362-43-16-O-C--9′-4-×10′
   CANT-362-43-16-O-C-10′×10′
   CANT-362-43-16-O-C-10′-8-×10′
3—CANT-600-43-16-O.C.
   CANT-600-43-16-O-C--1′-4-×10′
   CANT-600-43-16-O-C--2′-8-×10′
   CANT-600-43-16-O-C--2′×10′
   CANT-600-43-16-O-C--3′-4-×10′
   CANT-600-43-16-O-C--4′×10′
   CANT-600-43-16-O-C--4′-8-×10′
   CANT-600-43-16-O-C--5′-4-×10′
   CANT-600-43-16-O-C--6′×10′
   CANT-600-43-16-O-C--6′-8-×10′
   CANT-600-43-16-O-C--7′-4-×10′
   CANT-600-43-16-O-C--8′×10′
   CANT-600-43-16-O-C--8′-8-×10′
   CANT-600-43-16-O-C--9′-4-×10′
   CANT-600-43-16-O-C-10′×10′
   CANT-600-43-16-O-C-10′-8-×10′
4—CANT-600-54-16-O.C.
   CANT-600-54-16-O-C--1′-4-×10′
   CANT-600-54-16-O-C--2′-8-×10′
   CANT-600-54-16-O-C--2′×10′
   CANT-600-54-16-O-C--3′-4-×10′
   CANT-600-54-16-O-C--4′×10′
   CANT-600-54-16-O-C--4′-8-×10′
   CANT-600-54-16-O-C--5′-4-×10′
   CANT-600-54-16-O-C--6′×10′
   CANT-600-54-16-O-C--6′-8-×10′
   CANT-600-54-16-O-C--7′-4-×10′
   CANT-600-54-16-O-C--8′×10′
   CANT-600-54-16-O-C--8′-8-×10′
   CANT-600-54-16-O-C--9′-4-×10′
   CANT-600-54-16-O-C-10′×10′
   CANT-600-54-16-O-C-10′-8-×10′
B.2—Full Panels
1—FULL-362-33-16-O.C.
   FULL-362-33-16-O-C--1′-4-×10′
   FULL-362-33-16-O-C--2′-8-×10′
   FULL-362-33-16-O-C--2′×10′
   FULL-362-33-16-O-C--3′-4-×10′
   FULL-362-33-16-O-C--4′×10′
   FULL-362-33-16-O-C--4′-8-×10′
   FULL-362-33-16-O-C--5′-4-×10′
   FULL-362-33-16-O-C--6′×10′
   FULL-362-33-16-O-C--6′-8-×10′
   FULL-362-33-16-O-C--7′-4-×10′
   FULL-362-33-16-O-C--8′×10′
   FULL-362-33-16-O-C--8′-8-×10′
   FULL-362-33-16-O-C--9′-4-×10′
   FULL-362-33-16-O-C--10′×10′
   FULL-362-33-16-O-C--10′-8-×10′
2—FULL-362-43-16-O.C.
   FULL-362-43-16-O-C--1′-4-×10′
   FULL-362-43-16-O-C--2′-8-×10′
   FULL-362-43-16-O-C--2′×10′
   FULL-362-43-16-O-C--3′-4-×10′
   FULL-362-43-16-O-C--4′×10′
   FULL-362-43-16-O-C--4′-8-×10′
   FULL-362-43-16-O-C--5′-4-×10′
   FULL-362-43-16-O-C--6′×10′
   FULL-362-43-16-O-C--6′-8-×10′
   FULL-362-43-16-O-C--7′-4-×10′
   FULL-362-43-16-O-C--8′×10′
   FULL-362-43-16-O-C--8′-8-×10′
   FULL-362-43-16-O-C--9′-4-×10′
   FULL-362-43-16-O-C--10′×10′
   FULL-362-43-16-O-C--10′-8-×10′
3—FULL-600-43-16-O.C.
   FULL-600-43-16-O-C--1′-4-×10′
   FULL-600-43-16-O-C--2′-8-×10′
   FULL-600-43-16-O-C--2′×10′
   FULL-600-43-16-O-C--3′-4-×10′
   FULL-600-43-16-O-C--4′×10′
   FULL-600-43-16-O-C--4′-8-×10′
   FULL-600-43-16-O-C--5′-4-×10′
   FULL-600-43-16-O-C--6′×10′
   FULL-600-43-16-O-C--6′-8-×10′
   FULL-600-43-16-O-C--7′-4-×10′
   FULL-600-43-16-O-C--8′×10′
   FULL-600-43-16-O-C--8′-8-×10′
   FULL-600-43-16-O-C--9′-4-×8′
   FULL-600-43-16-O-C--10′×8′
   FULL-600-43-16-O-C--10′-8-×8′
4—FULL-600-54-16-O.C.
   FULL-600-54-16-O-C--1′-4-×8′
   FULL-600-54-16-O-C--2′-8-×8′
   FULL-600-54-16-O-C--2′×8′
   FULL-600-54-16-O-C--3′-4-×8′
   FULL-600-54-16-O-C--4′×8′
   FULL-600-54-16-O-C--4′-8-×8′
   FULL-600-54-16-O-C--5′-4-×8′
   FULL-600-54-16-O-C--6′×8′
   FULL-600-54-16-O-C--6′-8-×8′
   FULL-600-54-16-O-C--7′-4-×8′
   FULL-600-54-16-O-C--8′×10′
   FULL-600-54-16-O-C--8′-8-×10′
   FULL-600-54-16-O-C--9′-4-×8′
   FULL-600-54-16-O-C--10′×8′
   FULL-600-54-16-O-C--10′-8-×8′

What is claimed is:

1. A system for designing, engineering and constructing a building using prefabricated framing components comprising:
a database of pre-defined, prefabricated framing components each having a structural data profile,
a memory;
a user interface for receiving as input a building plan;
a processor coupled to the memory, the user interface and the database, and programmed with executable instructions including an analytics engine,
wherein the analytics engine
(a) structurally analyzes the received building plan;
(b) based on said structural analysis creates a panelized construction plan to construct said building using only said prefabricated framing components; and
(c) based on panelized construction plan, creates from said database a schedule containing an appropriate type and number of each of said plurality components to complete said construction plan.

2. The system of claim 1 wherein said pre-defined pre-fabricated framing components comprise at least:
a plurality of cantilevered panels,
a plurality of full panels,
a plurality of corner components, and
a plurality of universal connection tracks.

3. The system of claim 2 wherein said plurality of cantilevered panels comprise cantilevered panels which are open on opposing sides.

4. The system of claim 2 wherein said plurality of cantilevered panels comprise cantilevered panels which are open on one side.

5. The system of claim 2 further comprising convertible panels which interfit with open ends of the cantilevered panels.

6. The system of claim 2 wherein said pre-defined prefabricated framing components further comprise a plurality of cassette panels each having a structural data profile.

7. The system of claim 2 wherein sidewalls of cantilevered ends of each cantilevered panel and sidewalls of said universal connection tracks each include mating dimple holes for alignment, fastening, and to host a termination/end stud wherever needed to terminate the end of the panel.

8. The system of claim 1 wherein said structural data profile comprises a data set including at least a stud width, a stud wall thickness, an on-center dimension, a panel width and a panel height.

9. The system of claim 2 wherein said structural data profile comprises a data set including at least a stud width, a stud wall thickness, an on-center dimension, a panel width and a panel height.

10. The system of claim 7 wherein said structural data profile comprises a data set including at least a stud width, a stud wall thickness, an on-center dimension, a panel width and a panel height.

11. A framing component system for use in producing framed structural walls in a building construction comprising:
a plurality of pre-defined pre-fabricated framing components comprising at least:
a plurality of cantilevered panels each having horizontal top and bottom tracks and a plurality of vertical studs secured therebetween,
a plurality of full panels each having horizontal top and bottom tracks and a plurality of vertical studs secured therebetween,
a plurality of convertible panels each having horizontal top and bottom tracks and a vertical stud secured between at one end thereof,
a plurality of cassette panels each having horizontal top and bottom tracks and a plurality of vertical studs secured therebetween,
a plurality of termination studs and
a plurality of corner components each having horizontal top and bottom tracks and a plurality of vertical studs secured therebetween; and
a plurality of universal connection tracks for interconnecting said panels into a framed structural wall.

12. The system of claim 11 wherein said plurality of cantilevered panels comprise cantilevered tracks which are open on opposing sides.

13. The system of claim 11 wherein said plurality of cantilevered panels comprise cantilevered tracks which are open on one side.

14. The system of claim 11 wherein said plurality of cassette panels are configured and arranged to slidably accept door and window components between the top and bottom tracks and vertical studs.

15. The system of claim 11 wherein sidewalls of the cantilevered top and bottom tracks of said panels and sidewalls of said universal connection tracks each include mating dimple holes for alignment and fastening of adjacent panels together, and for securing termination studs to terminate an end of a predetermined panel.

16. The system of claim 12 wherein sidewalls of the cantilevered top and bottom tracks of said panels and sidewalls of said universal connection tracks each include mating dimple holes for alignment and fastening of adjacent panels together, and for securing termination studs to terminate an end of a predetermined panel.

17. The system of claim 13 wherein sidewalls of the cantilevered top and bottom tracks of said panels and sidewalls of said universal connection tracks each include mating dimple holes for alignment and fastening of adjacent panels together, and for securing termination studs to terminate an end of a predetermined panel.

18. The system of claim 14 wherein sidewalls of the cantilevered top and bottom tracks of said panels and sidewalls of said universal connection tracks each include mating dimple holes for alignment and fastening of adjacent panels together, and for securing termination studs to terminate an end of a predetermined panel.

19. The system of claim 11 further comprising a C-shaped horizontal bridging component configured and arranged to slide over said top and bottom track components.

20. The system of claim 19 wherein the horizontal bridging component comprises telescoping portions which are slidably adjustable in length.
